(19) United States
(12) Patent Application Publication
(10) Pub. No.: US 2025/0373972 A1
(43) Pub. Date: Dec. 4, 2025

(54) EARPHONE

(71) Applicant: Anker Innovations Technology Co., Ltd., Changsha (CN)

(72) Inventor: Jin Zhang, Shenzhen (CN)

(21) Appl. No.: 19/085,632

(22) Filed: Mar. 20, 2025

(30) Foreign Application Priority Data
Jun. 3, 2024 (CN) 202421250592.8

(51) Int. Cl. H04R 1/10

(52) U.S. Cl. CPC H04R 1/1066; H04R 1/1008; H04R 1/105; H04R 1/1075; H04R 1/1025

(57) ABSTRACT

Disclosed is an earphone including a sound emitting unit, an ear hook and a limiting structure. The sound emitting unit includes an earphone housing provided with an opening and a guide groove communicating with the opening; the ear hook includes an ear hook body and a connector connected with each other, in which the ear hook body penetrates through the opening, and the connector is disposed in the guide groove and is movable along the guide groove; and the limiting structure includes a first limiting portion and a second limiting portion, which are elastically abutted against each other and are movable relative to each other. The connector of the ear hook is connected with the earphone housing, and the sound outlet can be aligned with the ear canal opening of the ear of different users as much as possible, achieving an optimal listening effect.

### CROSS-REFERENCE TO RELATED APPLICATIONS

The present disclosure claims priority to Chinese Patent Application No. 202421250592.8, filed on Jun. 3, 2024, the entire disclosures of which are incorporated herein by reference.

### FIELD

The present disclosure relates to the technical field of earphones, particularly to an earphone.

### BACKGROUND

Open-ear earphones are a type of earphones that do not completely seal the ear canal, allowing external sounds to enter the ear while also transmitting sound waves to the inner ear nerves. This design reduces pressure on the ear canal during wear, ensuring comfort over extended periods of usage. It also helps to maintain ventilation and dryness in the ear canal, thus providing a more comfortable wearing experience. In addition, the open-ear earphones are also designed to prevent auditory fatigue and is more suitable for prolonged use.

An ear hook structure and an earphone housing structure are key parts of the open-ear earphone design, as they collectively determine the stability and comfort of wearing the earphones. In the related designs, once the user wears the earphone on the ear using the ear hook structure, a position of a sound outlet on the earphone housing structure is relatively fixed, which may lead to a poor alignment between the sound outlet and the user's ear canal opening, thereby reducing the listening effect or experience.

### SUMMARY

The present disclosure provides an earphone which can adjust a position of a sound outlet, so that the sound outlet can better match or align with the user's ear canal opening, which can improve the listening effect.

The present disclosure provides an earphone including a sound emitting unit, an ear hook and a limiting structure.

The sound emitting unit includes an earphone housing provided with an opening and a guide groove communicating with the opening; the ear hook includes an ear hook body and a connector connected with each other, the ear hook body penetrates through the opening, and the connector is disposed in the guide groove and is movable along the guide groove; and the limiting structure includes a first limiting portion arranged on one of the connector and the earphone housing and a second limiting portion arranged on the other of the connector and the earphone housing; the first limiting portion and the second limiting portion are elastically abuts against each other and are movable relative to each other.

According to the earphone of the examples of the disclosure, by providing the connector connected to the guide groove in a slidable manner, the user can adjust the position of the sound outlet on the earphone housing by sliding between the earphone housing and the connector of the ear hook according to the shape and size of his own auricle. This adjustment enables the sound outlet on the earphone housing to be aligned as closely as possible with the user's ear canal opening, thereby improving the acoustic performance of the earphone and improving the user's listening effect and experience.

In the examples of the disclosure, a first limiting portion and a second limiting portion are further provided. For example, the first limiting portion includes an elastic sheet or a ball. The second limiting portion includes a damping sheet. The first limiting portion can be provided on the earphone housing or the connector, and moves relative to and elastically abuts against the second limiting portion. That is, after adjusted to a proper position, the interaction between the first limiting portion and the second limiting portion allows the relative position between the earphone housing and the connector to be fixed, so that the sound emitting unit can be securely positioned at an optimal position, preventing unintended displacement between the earphone housing and the ear hook, thereby enhancing reliability of long-time wear.

In the solution of the disclosure, a guide groove is formed in the earphone housing, and the connector of the ear hook extends from the opening into the guide groove to realize sliding connection. This adjustment structure is simple in form and makes full use of the internal space of the earphone housing, so that the entire earphone is compact and lightweight, which is more suitable to long-time wear by a user.

### BRIEF DESCRIPTION OF DRAWINGS

In order to more clearly illustrate technical solutions in the present disclosure or in the related art, drawings that need to be used in description of the present disclosure or the related art are briefly introduced below, and it will be apparent to those of ordinary skill in the art that the drawings in the following description are merely some examples of the disclosure, and other drawings may be obtained in accordance with structures shown in these drawings without inventive work.

FIG. 1 is a schematic diagram showing a structure of an earphone according to an example of the present disclosure;

FIG. 2 is a schematic diagram showing an exploded structure of an example of the earphone in FIG. 1;

FIG. 3 is a schematic diagram showing an exploded structure of another example of the earphone in FIG. 1;

FIG. 4 is a schematic diagram showing an exploded structure of yet another example of the earphone in FIG. 1;

FIG. 5 is an enlarged diagram of area A in FIG. 4;

FIG. 6 is a schematic diagram showing a structure of an earphone according to another example of the present disclosure;

FIG. 7 is a wearing diagram of an example of the earphone in FIG. 6;

FIG. 8 is a schematic diagram showing an exploded structure of an example of the earphone in FIG. 6;

FIG. 9 is a schematic diagram showing an exploded structure of another example of the earphone in FIG. 6;

FIG. 10 is a schematic diagram showing an exploded structure of yet another example of the earphone in FIG. 6;

FIG. 11 is an enlarged diagram of area B in FIG. 10;

FIG. 12 is a schematic diagram showing an exploded structure of still another example of the earphone in FIG. 6;

FIG. 13 is an enlarged diagram of area C in FIG. 12;

FIG. 14 is a schematic diagram showing an exploded structure of still another example of the earphone in FIG. 6;

FIG. 15 is an enlarged diagram of area D in FIG. 14;

FIG. 16 is a schematic diagram showing an exploded structure of still another example of the earphone in FIG. 6; and

FIG. 17 is a schematic diagram showing a further exploded structure of the earphone in FIG. 16.

### DESCRIPTION OF REFERENCE NUMERALS

100: earphone; 10: sound emitting unit; 11: earphone housing; 11a: opening; 11b: guide groove; 11c: accommodating cavity; 111: housing; 1111: abutment surface; 1111a: sound outlet; 1112: side surface; 1113: first housing; 11131: annular waterproof groove; 1114: second housing; 11141: annular waterproof boss; 112: partition; 112a: wire passing hole; 112b: first mounting groove; 112d: second mounting groove; 12: speaker driver; 20: ear hook; 21: ear hook body; 22: connector; 22a: wire exiting hole; 30: limiting structure; 31: first limiting portion; 311a: elastic sheet; 3111a: bending portion; 312a: limiting protrusion; 311b: sleeve; 312b: jacking piece; 32: second limiting portion; 32a: limiting groove; 40: battery compartment; 41: cover housing; 42: battery; 50: wire; 60: sealing ring; 60a: annular groove.

Achievement of the object, functional features and advantages of the disclosure will be further described in combination with examples and with reference to the accompanying drawings.

### DETAILED DESCRIPTION

In order to make understanding of the object, technical solutions and advantages of the present disclosure clearer, the present disclosure will be described in further detail below with reference to the accompanying drawings.

When the following description refers to the drawings, the same numerals in different drawings represent the same or similar elements unless otherwise indicated. Implementations to be described in the following exemplary examples do not represent all implementations according to the present disclosure. Rather, they are merely examples of a device and method according to some aspects of the present disclosure as detailed in the appended claims.

It should be understood that in the description of the present disclosure, the terms “first”, “second”, and the like are used for descriptive purposes only and should not be construed as indicating or implying relative importance. Specific meanings of the above terms in the disclosure may be understood in specific circumstances by those skilled in the art. Moreover, “a plurality of” means two or more unless otherwise stated in the description of the disclosure. “And/or” describes an associated relationship and indicates that there may be three relationships. For example, A and/or B may mean: three cases of A alone, both A and B, and B alone. The character “/” generally indicates that the former and latter associated objects are in an “or” relationship.

Unless defined otherwise, all technical and scientific terms used herein have the same meaning as commonly understood by those of ordinary skill in the art of the disclosure. The terms used in the description are only for the purpose of describing specific examples and are not taken as a limitation of the present disclosure. The term “and/or” as used herein includes any and all combinations of one or more related listed items.

An earphone is an audio playing device, which is mainly used for personal listening needs. An earphone includes a pair of conversion units, which can receive electric signals from a media player or a receiver and convert the electric signals into audible sound waves through speakers close to an ear.

With the continuous development of earphone technology, users have increasingly higher expectations for both comfort of wearing and acoustic performance of earphones. Open-ear earphones, which do not block the ear canal, can reduce pressure on the ear canal, allowing for extended wear without discomfort, while also keeping the ear canal ventilated and dry. This design enables users to enjoy music while still being aware of external sounds, such as ambient noise and speaking voices of other people. This design not only improves the comfort of wearing, but also does not cause discomfort even if the earphone is worn for an extended time by eliminating the feeling of ear compression. In addition, their ability to maintain connectivity with the surrounding environment facilitates communication. Therefore, these earphones are becoming more popular among consumers.

There is a form of an open-ear earphone structure worn to the ear through an ear hook. This type of earphone structure includes the ear hook and a sounding structure connected with the ear hook. In the related design, the ear hook and the earphone housing of the sounding structure are fixedly connected. In this structure form, a position of the sound outlet on the earphone housing relative to an ear canal opening cannot be adjusted during wearing, which may cause sound not to be accurately transferred to the ear, affecting sound performance and rendering poor listening effect.

In the related art, in order to adjust the position of the sound outlet, the open-ear earphone has a complicated gear structure or hinge structure provided between the ear hook and the earphone housing. This design has a large structure of the earphone housing to accommodate and install parts such as gear and hinge, which makes the overall structure of the earphone bulky and increases the weight of the earphone, and may cause the user's ear to feel uncomfortable when worn for a long time.

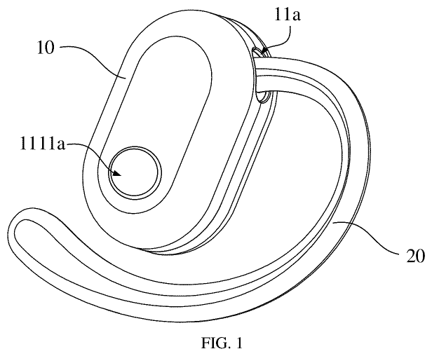

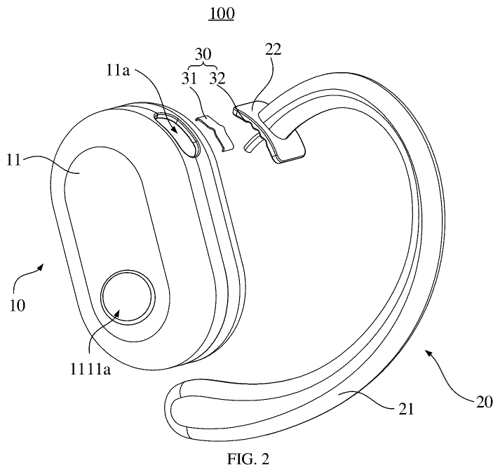

In order to solve the above problems, referring to FIG. 1 and FIG. 2 together, the disclosure proposes an earphone 100, which is an open-ear earphone and is in the form of air conduction. The earphone 100 includes a sound emitting unit 10 (e.g., a speaker) and an ear hook 20 connected with the sound emitting unit 10, the ear hook 20 being of a curved structure.

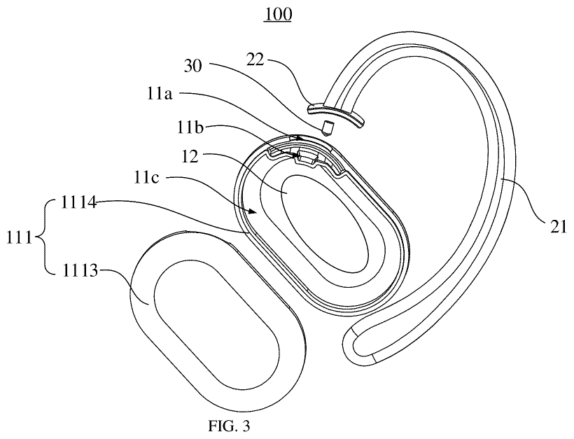

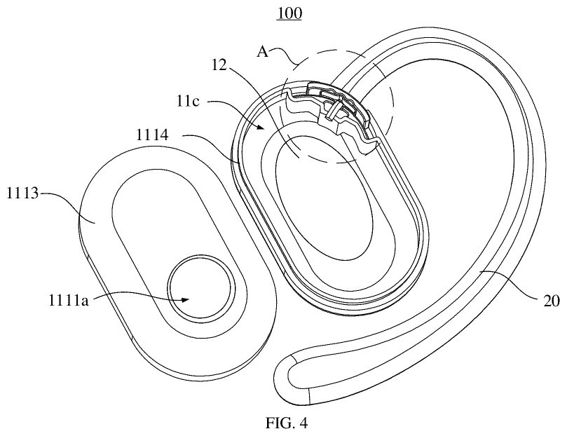

Referring to FIGS. 3 to 5, the sound emitting unit 10 includes an earphone housing 11 and a speaker driver 12. The material of the earphone housing 11 may be plastic, metal, silica gel, and the like. The earphone housing 11 can be constructed in a relatively flat form, so that after the earphone 100 is worn, the sound emitting unit 10 can better fit the ear, which can improve stability and comfort during wearing. An accommodating cavity 11c is formed in the earphone housing 11, and the speaker driver 12 is accommodated in the accommodating cavity 11c. The earphone housing 11 is further provided with a sound outlet 1111a, which is an important part of the sound emitting unit 10 of the earphone and is used to directionally output sound waves generated by a sounding unit inside the earphone to an ear canal opening of a user. In this example, the sound outlet 1111a is designed to at least partially cover the user's ear canal opening to optimize sound transmission. The sound generated by the speaker driver 12 during operation propagates outward through the sound outlet 1111a.

An end of the ear hook 20 is connected with the earphone housing 11. The entire ear hook 20 has a certain deformability, and an overall shape thereof fits a shape of the back of the auricle. In some examples, the ear hook 20 may include a rod-shaped body made of plastic, and a memory wire is embedded in the rod-shaped body. Through such a structural form, the ear hook 20 has good durability and bending ability, making it more resistant to pulling forces during wear and allowing it to easily return to its original shape.

The earphone 100 of the present disclosure has a battery 42 that can supply power to the speaker driver 12, and the specific form of the battery is not limited, for example, a lithium battery that can be charged and discharged repeatedly can be used, so that the earphone 100 is convenient to use and carry.

In a structural form, the battery can be accommodated in the accommodating cavity 11c, and in this case, the entire earphone 100 is divided into two parts. It can also be called a two-section type. It can be understood that in the case of two-section design, a wire between the battery and the speaker driver 12 is relatively short, and wiring is relatively simple. At this time, an overall mass of the earphone 100 is more concentrated on the sound emitting unit 10, and in order to make the entire earphone 100 more stable during wearing, the length of the ear hook 20 can be correspondingly extended, for example, an end of the ear hook 20 away or distal from the sound emitting unit 10 can extend to a position corresponding to the earlobe. In this way, the ear hook 20 has a larger contact area with the ear, so that the earphone 100 can be stably worn to the ear.

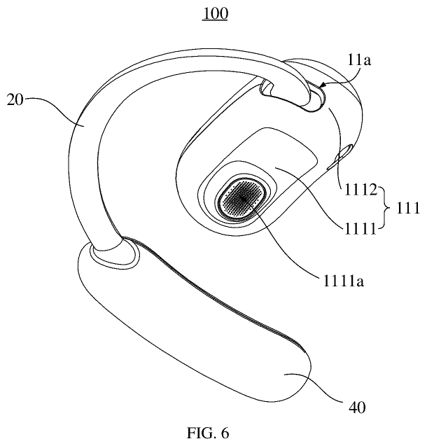

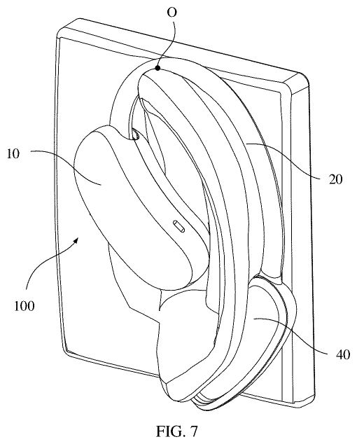

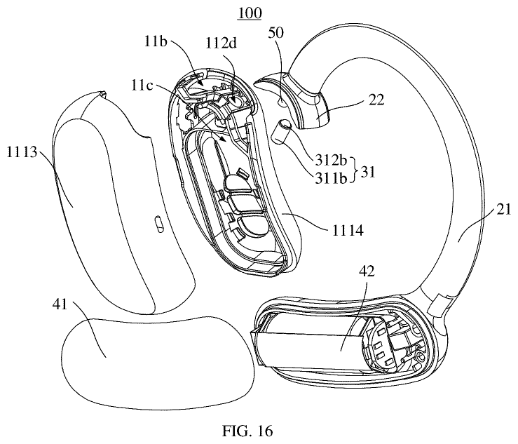

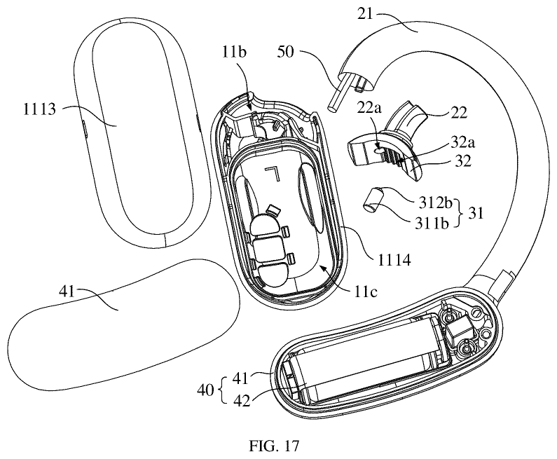

Referring to FIGS. 6 and 7, in another structural form, the earphone 100 further includes a battery compartment 40 in addition to the sound emitting unit 10 and the ear hook 20. As shown in FIGS. 16 and 17, the battery compartment 40 includes a cover housing 41 and a battery 42 accommodated in the cover housing 41. That is, in this example, the earphone 100 is provided with three parts: the sound emitting unit 10, the ear hook 20 and the battery compartment 40, and thus has a three-section structure. The battery compartment 40 is connected or coupled to an end of the ear hook 20 away or distal from the sound emitting unit 10. FIG. 7 shows a form of the earphone 100 mounted outside a user's ear in an actual wearing and use process. As can be seen from the drawing, in the wearing process, the ear hook 20 is mounted on the back of the auricle of the ear, and the sound emitting unit 10 extends from a position of the crus of helix to a position of the cavum conchae, and the position of the sound outlet 1111a matches the position of the ear canal opening, so that the sound output by the speaker driver 12 is directionally propagated to the ear canal opening through the sound outlet 1111a. The battery compartment 40 is located on the back of the auricle and corresponds to a position of the earlobe.

The three-section structure design helps to distribute the weight of the earphone 100 more evenly, improves the comfort performance during wearing, and makes maintenance of the independent battery compartment 40 more convenient. Because the independent battery compartment 40 can provide larger installation space for the battery 42, it is easier to design the battery 42 with greater capacity, which has an enhanced durability of the earphone 100 correspondingly.

Further, in this disclosure, in order to adjust the position of the sound outlet 1111a, in any of the above examples, the earphone housing 11 is provided with an opening 11a and a guide groove 11b communicating with the opening 11a; the ear hook 20 includes an ear hook body 21 and a connector 22 connected with each other, in which the ear hook body 21 penetrates through the opening 11a, and the connector 22 is located in the guide groove 11b and can slide along the guide groove 11b. Moreover, the earphone 100 further includes a limiting structure 30 which includes a first limiting portion 31 and a second limiting portion 32. For example, the first limiting portion includes an elastic sheet or a ball. The second limiting portion includes a damping sheet. The first limiting portion 31 is provided or arranged on one of the connector 22 and the earphone housing 11, and the second limiting portion 32 is provided or arranged on the other of the connector 22 and the earphone housing 11; the first limiting portion 31 elastically abuts against the second limiting portion 32; and the first limiting portion 31 can move relative to the second limiting portion 32.

In this example, the connector 22 is connected to the guide groove in the earphone 100 (e.g., in a sliding manner), and the user can adjust the position of the sound outlet 1111a on the earphone housing 11 by sliding between the earphone housing 11 and the connector 22 of the ear hook 20 according to the shape and size of his own auricle, so that the sound outlet 1111a on the earphone housing 11 can be adjusted to be aligned as closely as possible to the user's ear canal opening, thereby improving the acoustic performance of the earphone 100 and improving the user's listening effect and experience.

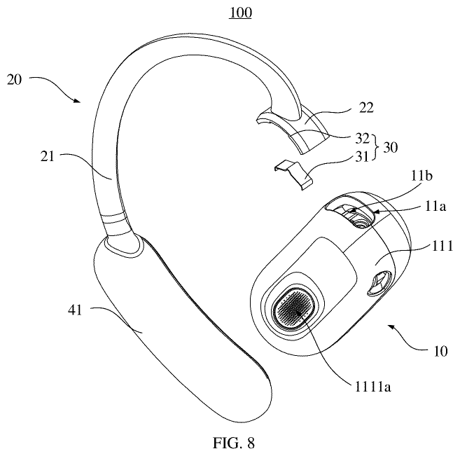

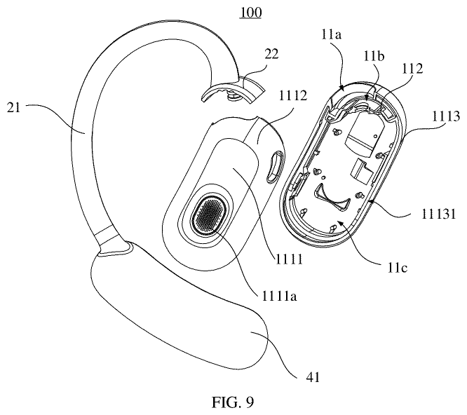

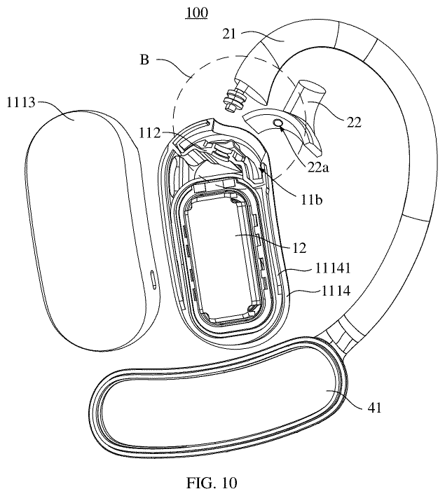

Referring to FIG. 8, FIG. 9 and FIG. 10, the earphone housing 11 includes a housing 111 and a partition 112 provided inside the housing 111. The partition 112 and one part of an inner wall of the housing 111 define the guide groove 11b, and the partition 112 and the other part of the inner wall of the housing 111 define the accommodating cavity 11c. The opening 11a is formed on the housing 111.

In order to facilitate assembly, in some structural forms, the housing 111 includes a first housing 1113 and a second housing 1114 which are connected with each other in a snap-fit manner. The snap-fit design provides greater design flexibility, and the shapes and sizes of the first housing 1113 and the second housing 1114 can be adjusted according to different functional requirements, and the disassembly, assembly and maintenance are convenient.

In order to improve a waterproof ability, an edge portion of the first housing 1113 is provided with an annular waterproof groove 11131 along a circumferential direction thereof, and an edge portion of the second housing 1114 is provided with an annular waterproof boss 111141 which fits the annular waterproof groove 11131. After the first housing 1113 and the second housing 1114 are snap fit with each other, the annular waterproof boss 11141 is clamped into the annular waterproof groove 11131, which can effectively prevent external liquid from entering the accommodating cavity 11c, better protect components inside the earphone housing, reduce damage caused by moisture invasion, and prolong the service life of the earphone 100. The entire earphone housing 11 can be blocked at the joint through fitting of the annular waterproof boss 11141 and the annular waterproof groove 11131, that is, effect of hiding the joint is achieved, thereby enhancing aesthetics of the earphone housing 11.

It can be understood that in order to further enhance tightness of the connection between the first housing 1113 and the second housing 1114 and improve the waterproof and sweat-proof function of the earphone housing 11, the first housing 1113 and the second housing 1114 can be fixedly connected by ultrasonic welding or gluing. The connection mode between the first housing 1113 and the second housing 1114 can be others when the connection effect can be achieved, which is not limited by this disclosure.

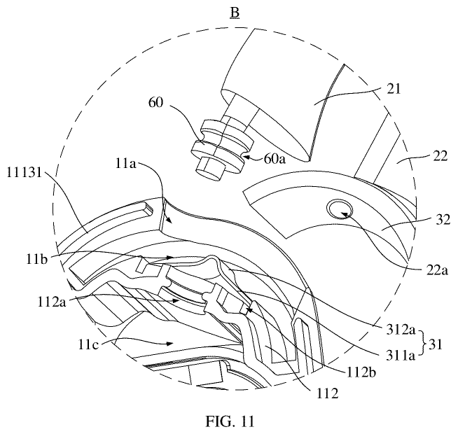

Referring to FIG. 11, the partition 112 may include two parts in half, and the two parts of the partition 112 are respectively connected to inner walls of the first housing 1113 and the second housing 1114. After the first housing 1113 and the second housing 1114 are snap fit, the two parts of the partition 112 are spliced. The partition 112 may also be one unit and is connected to an inner wall of one of the first housing 1113 and the second housing 1114. After the first housing 1113 and the second housing 1114 are snap fit, the partition 112 seals and abuts against the other of the first housing 1113 and the second housing 1114, and thus the partition 112 can fit part of the inner walls of the first housing 1113 and the second housing 1114 to define the above guide groove 11b.

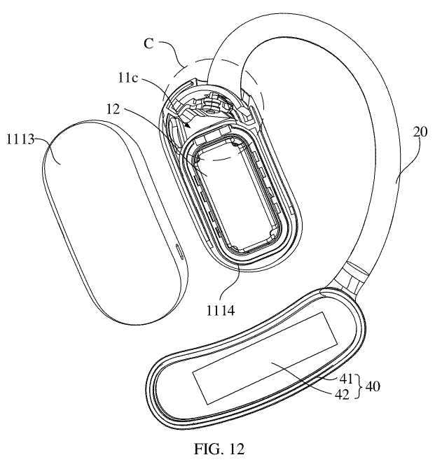

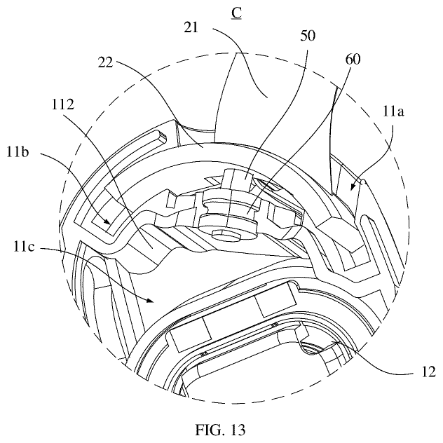

In the three-section earphone 100, as shown in FIG. 11, FIG. 12 and FIG. 13, the earphone 100 further includes a wire 50 and a sealing ring 60 fitted outside the wire 50. To connect the speaker driver 12 in the accommodating cavity 11c with the battery 42 in the battery compartment 40 through the wire 50, the connector 22 can be provided with a wire exiting hole 22a for the wire 50 to pass through, and the partition 112 is provided with a wire passing hole 112a at a position opposite to the wire exiting hole 22a. The wire passing hole 112a connects the accommodating cavity 11c with the guide groove 11b, and is used for guiding the wire 50 from the accommodating cavity 11c via the guide groove 11b into the ear hook body 21 through the wire exiting hole 22a, and finally into the battery compartment 40. This wiring form can prevent the wire in the earphone 100 from being disordered due to much winding, and connects the wiring part and the speaker driver 12 by the wire 50 in the ear hook body 21, which can make the structure more compact.

In order to prevent the speaker driver 12 in the accommodating cavity 11c from being corroded by moisture and sweat, the sealing ring 60 is fitted on an end of the wire 50 away or distal from the battery compartment 40, and the sealing ring 60 is embedded in the wire passing hole 112a to reduce generation of assembly clearance. Moreover, the connection between the sealing ring 60 and the wire passing hole 112a can provide cushioning and support for the wire 50 and prevent the wire 50 from being easily scratched at the wire passing hole 112a, thus ensuring safety of an internal circuit of the earphone 100 and preventing potential short circuits or damage.

Further, an outer wall of the sealing ring 60 is provided with an annular groove 60a, and the inner wall of the wire passing hole 112a is provided with an annular protrusion fitting the annular groove 60a, so that the sealing ring 60 and the wire passing hole 112a form closer sealed connection, which effectively prevents moisture, dust and other foreign matters from entering the earphone 100. The enhanced sealed connection contributes to improving the waterproof and sweat-proof grade of the earphone 100, making the earphone 100 more suitable for use in moist or humid environments.

For example, the sealing ring 60 may be a plastic waterproof (SR) sealing ring 60, which can provide good sealing performance in different working environments, can effectively prevent inflow of external fluid in both static and dynamic applications, and has strong corrosion resistance, will not be easily damaged and aged, and can prolong the service life of the earphone 100.

The ear hook body 21 is a rod-shaped structure including a rod-shaped body made of plastic, and a memory metal wire is provided in the rod-shaped body of the ear hook body 21. The connector 22 may be made of the same material as the rod-shaped body of the ear hook body 21, and is produced by integral injection molding. In the three-section structure, the end of the ear hook body 21 away or distal from the earphone housing 11 is connected with the cover 41 of the battery compartment 40. The rod-shaped body of the ear hook body 21 can be made of thermoplastic polyurethane (TPU) soft rubber, which is more comfortable for a user to wear and will not cause earache after being worn for a long time. The connector 22 may be made of acrylonitrile-butadiene-styrene plastic (ABS) hard rubber, which has high structural strength and rotates smoother. The ear hook body 21 and the connector 22 are integrated by secondary injection molding, which increases connection firmness therebetween. In other structural forms, the connector 22 and the ear hook body 21 may also be separate, and the connector 22 is fixed to the ear hook body 21 by bonding, welding, and the like, or by other connection forms such as threaded connection and clamping, which is not limited in this disclosure.

Further, the guide groove 11b of the disclosure extends along the circumferential direction of the earphone housing 11, and two ends of the guide groove 11b are respectively provided with a first limiting surface and a second limiting surface, between which the connector 22 slides, and the first limiting surface and the second limiting surface can provide a clear adjustment range for sliding of at least part of the ear hook 20 to ensure that a user adjusts the earphone 100 within an effective use limit. In this example, an opening length of the opening 11a is smaller than a distance between the first limiting surface and the second limiting surface, and a length of the connector 22 is larger than the opening length of the opening 11a, which can prevent the connector 22 from sliding off the opening 11a. It can be understood that the design that the length of the connector 22 is larger than the opening length of the opening 11a is only a feasible way to prevent the connector 22 from sliding off the opening 11a. Other designs can include that when the connector 22 is located between the first limiting surface and the second limiting surface, a width of the connector 22 is larger than a width of the opening 11a, or other limiting structures.

In order to further describe a positional relationship between the sound outlet 1111a and the opening 11a on the earphone housing 11, an outer surface of the housing 111 can be divided into an abutment surface 1111 and a side surface 1112 (as shown in FIG. 6) according to a state in which the earphone 100 contacts the ear when worn. The abutment surface 1111 is a surface that contacts the ear when the earphone 100 is worn, and the side surface 1112 is connected to the periphery of the abutment surface 1111 and does not come into contact with the ear when the earphone 100 is worn. In a case where the earphone housing 11 is designed in a flat structure, the side surface 1112 can also be considered as a surface of the earphone housing 11 extending in the thickness direction. For example, as shown in FIGS. 9 and 10, the sound outlet 1111a is provided on the first housing 1113, the abutment surface 1111 is a surface of the first housing 1113 provided with the sound outlet 1111a, and the side surface 1112 is jointly defined by the first housing 1113 and the second housing 1114. The sound outlet 1111a is opened on the abutment surface 1111, which can ensure that sound is directly transmitted to the ear canal of the user when the earphone 100 is worn, and reduce loss of the sound during transmission. The opening 11a is opened on the side surface 1112, so that the user can operate the ear hook 20 exposed outside the opening 11a more easily and drive the connector 22 in the guide groove 11b to slide, and the connection position between the ear hook 20 and the earphone housing 11 is not easy to interfere with the user's ear skin in the adjustment process.

Further, at least part of the abutment surface 1111 is of a frustum cone-shaped structure and defines the sound outlet 1111a on the frustum cone-shaped structure. The frustum cone-shaped structure makes the sound outlet 1111a more closely fit the ear canal, forming a certain degree of sealing and positioning effect, thus enhancing low-frequency response. The frustum cone-shaped abutment surface 1111 can provide better support and friction, which contributes to stable wearing of the earphone 100 on the ear.

In the wearing state, the earphone 100 of this example can be supported at the cavum conchae, cymba conchae and helix of the user to realize wearing of the acoustic device, and the earphone housing 11 of the earphone 100 is completely or partially submerged in a groove formed by the cymba conchae and cavum conchae of the human ear, and the sound outlet 1111a is aligned with the user's ear canal opening, thereby increasing resistance of the open-ear earphone 100 against falling off the ear.

The earphone housing 11 has a length direction, and includes a first end and a second end located in the length direction. In the wearing state, the first end is closer to the crus of helix of the human ear than the second end, and the second end is closer to the ear canal opening of the human ear than the first end. The opening 11a is provided at the first end or an adjacent position thereof, which provides an intuitive and convenient adjustment position for the user. The ear hook 20 extending into the guide groove 11b can slide along the extending direction of the guide groove 11b, so as to fine-tune the position of the sound outlet 1111a and ensure that the sound outlet 1111a can be accurately aligned with the user's ear canal opening. This sliding adjustment mechanism is not only easy to operate, but also can realize fine adjustment to adapt to ear sizes and shapes of different users, thus providing personalized wearing experience.

In an example, the connector 22 is provided in an arc structure, and the shape of the guide groove 11b fits the shape of the connector 22, that is, the connector 22 is allowed to slide smoothly in the guide groove 11b to realize position adjustment. Referring to FIG. 7 again, during wearing, a contact point between the ear hook 20 and an upper part of the ear is defined as point O, but distances from the ear canal openings of different users to the point O are different. In this example, the earphone housing 11 is configured to have a length direction, the connector 22 is connected to the first end along the length direction, and the connector 22 and the guide groove 11b are set to mutually fitting arcs. Thus, it can be understood that in the adjustment process, the entire earphone housing 11 swings around the part connected to the connector 22, so that the earphone housing 11 can largely adjust the position of the sound outlet 1111a near the second end with a small swing angle, and a large adjustment range can be obtained with a small motion amplitude.

In other examples, the connector 22 may be in a linear structure or a circular structure, and the guide groove 11b fits the connector 22. At this time, a motion mode of the earphone housing 11 may be linear motion or swing.

Referring to FIG. 8 again, the limiting structure 30 of the disclosure can provide a stop point for the user after adjusting the position of the sound outlet 1111a, so that the user can stably position the earphone 100 after finding an optimal wearing position, and does not need to worry about unexpected change of the relative position between the earphone housing 11 and the ear hook 20, thus ensuring reliability of wearing for a long time. That is, the first limiting portion 31 can move relative to the second limiting portion 32 and generates elastic abutment, and the user can quickly slide the connector 22 and find a suitable wearing position by the elastic performance of the first limiting portion 31. The elastic abutment can reduce mechanical wear between the first limiting portion 31 and the connector 22 or the earphone housing 11, thereby improving the durability and service life of the earphone 100.

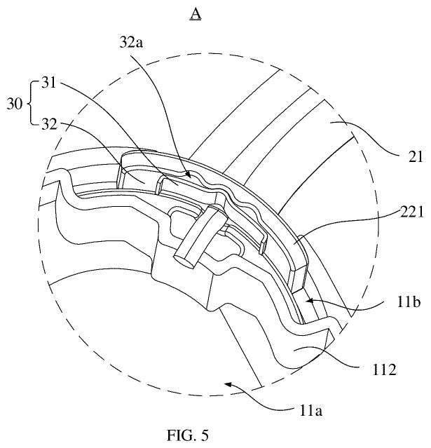

As shown in FIG. 5, the first limiting portion 31 can be provided or arranged on the earphone housing 11, and the second limiting portion 32 can be provided or arranged on the connector 22. It can be understood that the first limiting portion 31 can also be provided or arranged on the connector 22, and the second limiting portion 32 can be provided or arranged on the earphone housing 11.

In an example, the second limiting portion 32 has a wavy structure, that is, the second limiting portion 32 includes a plurality of concave portions and a plurality of convex portions arranged at intervals respectively. The wavy structure provides a plurality of concave portions connected in sequence, which allows a plurality of fixed positions of the first limiting portion 31 within a certain range, thus increasing the continuity of rotation of the first limiting portion 31. It can be understood that when the first limiting portion 31 stays at the convex position of the wavy structure, a damping effect can be generated, so that the connector 22 is not easy to loosen after adjustment.

Specifically, the second limiting portion 32 includes at least two limiting grooves 32a. While the connector 22 is sliding along the guide groove 11b, part of structure of the first limiting portion 31 can move to one of at least two limiting grooves 32a in sequence, and each of the limiting grooves 32a serves as a fixing point, which can ensure stability of the connector 22 when adjusted to a specific position and prevent the connector 22 from sliding or shifting during use of the earphone 100. Setting two or more limiting grooves 32a in this way can meet the requirement that the connector 22 can be well positioned at the adjusted position in the case of large-scale adjustment of the sound outlet 1111a, so as to meet the needs of different users.

It should be noted here that when the second limiting portion 32 is provided or arranged on the connector 22, the second limiting portion 32 may be an additional portion on the connector 22 which forms the limiting groove 32a and the wavy structure, or the additional portion fits the connector 22 to form the limiting groove 32a. In other examples, the second limiting portion 32 may be concave and convex space structures formed by the connector 22 itself, which is not limited by the disclosure.

For example, there are three limiting grooves 32a arranged in sequence. When the first limiting portion 31 moves from one limiting groove 32a to another adjacent limiting groove 32a, the ear hook 20 can rotate relative to the sound emitting unit 10 by a preset angle, such as 10 degrees or 20 degrees. In the solution of the disclosure, the hook 20 can also be specifically adjusted according to the actual situation, so that the sound outlet 1111a of the earphone 100 is aligned with the ear canal opening to obtain an optimal listening experience.

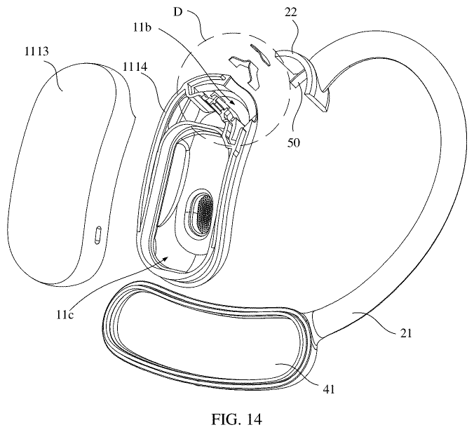

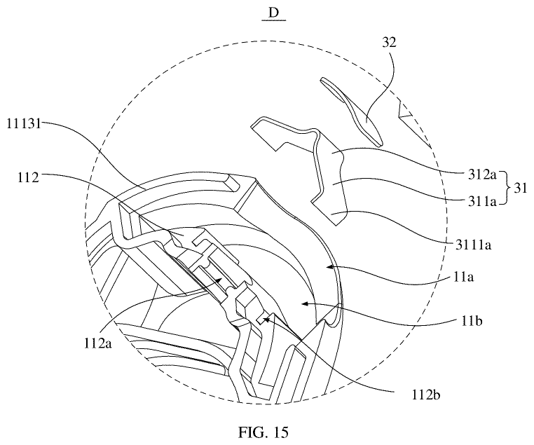

As shown in FIGS. 14 and 15, in another example, the second limiting portion 32 is a damping sheet. The damping sheet can be made of rubber, silica gel or other elastic materials. The damping sheet elastically abuts against and is movable relative to the first limiting portion 31. The damping sheet can be fixed on the connector 22 or the earphone housing 11. In this example, when the user does not apply an external force to the connector 22, the damping sheet can provide a damping force to maintain a relative position of the connector 22 in the guide groove 11b, and after the user adjusts the connector 22 according to wearing requirements, the ear hook 20 and the earphone housing 11 can keep the relative position unchanged, improving the user's experience. Setting the damping sheet can make the connector 22 stay at various tiny adjustment angles and realize stepless adjustment.

Continuing to refer to FIG. 14 and FIG. 15, in any of the above examples, the first limiting portion 31 may be an elastic sheet, and the elastic sheet may be made of metal, which is simple in structure, not easy to be damaged and relatively low in manufacturing cost. The elastic sheet includes an elastic sheet body 311a and a limiting protrusion 312a integrally formed. The limiting protrusion 312a is connected or coupled with the elastic sheet body 311a and protrudes from a side of the elastic sheet body 311a. The limiting protrusion 312a elastically abuts against the second limiting portion 32 and the limiting protrusion 312a is movable relative to the second limiting portion 32. For example, the limiting protrusion 312a can move into at least two limiting grooves 32a in sequence, so as to realize rotation of the ear hook 20. The design of the limiting protrusion 312a and the limiting groove 32a allows a certain degree of elastic adjustment. When squeezed by an external force, the limiting protrusion 312a can deform away from a direction of the external force; when the external force disappears, the limiting protrusion 312a recovers and abuts against the limiting groove 32a.

In an example, a groove wall of the guide groove 11b is provided with a first mounting groove 112b, and an end of the elastic sheet body 311a is provided with a bending portion 3111a which is provided or disposed in the first mounting groove 112b, thus providing a simple and stable mounting method and ensuring that the elastic sheet maintains at a fixed position for a long time of use. The assembly process is simplified and is easy for quick assembly and disassembly.

In other examples, as shown in FIG. 16 and FIG. 17, the first limiting portion 31 may also be a ball, which has a compact structure, does not significantly increase the volume of the earphone 100, and helps to keep the earphone 100 light and portable. The ball includes a sleeve 311b, a jacking piece 312b and a spring provided in the sleeve 311b, an end of the spring is connected with the sleeve 311b, and the other end is connected with the jacking piece 312b, so that the jacking piece 312b is movably arranged in the sleeve 311b. The jacking piece 312b elastically abuts against the second limiting portion 32 and the jacking piece 312b can move relative to the second limiting portion 32. For example, the jacking piece 312b can move into at least two limiting grooves 32a in sequence, so as to realize the rotation of the ear hook 20. The sleeve 311b is provided on the groove wall of the guide groove 11b. Specifically, the groove wall of the guide groove 11b is provided with a second mounting groove 112d, and at least part of the sleeve 311b is fixedly provided or disposed in the second mounting groove 112d, thus providing stable support and ensuring the stability of the earphone 100 during wearing and using. The ball can be customized according to specific design requirements of the limiting groove 32a, providing flexibility in design.

For example, the jacking piece 312b may be one of a spherical jacking piece, a cylindrical jacking piece and a wedge jacking piece. It can be understood that a specific structure of the jacking piece 312b of the ball in the disclosure may also be other structures.

The same or similar reference numerals in the drawings of examples of the present disclosure correspond to the same or similar parts. In the description of the present disclosure, it is to be understood that the terms “upper”, “lower”, “left”, “right”, and the like indicating relationships of directions and positions are based on relationships of directions and positions shown in the drawings, and are intended to be illustrative and simplify descriptions only and not to indicate or imply that the referred device or element must be provided in a particular direction, configured and operated in a particular direction. Therefore, the terms used to describe relationships of positions are intended to be illustrative only and are not intended to limit the present disclosure. For those skilled in the art, specific meanings of the above terms can be understood according to specific situations.

The above are only preferred examples of the present disclosure and are not intended to limit the disclosure. Any modifications, equivalent substitutions, improvements or the like within the spirit and principle of the disclosure should be included in the scope of the disclosure.

What is claimed is:

1. An earphone comprising:
a sound emitting unit comprising an earphone housing, wherein the earphone housing is provided with an opening and a guide groove communicating with the opening;
an ear hook comprising an ear hook body and a connector connected with each other, wherein the ear hook body penetrates through the opening, and the connector is disposed in the guide groove and is movable along the guide groove; and
a limiting structure comprising a first limiting portion and a second limiting portion, wherein the first limiting portion is arranged on one of the connector and the earphone housing, and the second limiting portion is arranged on the other of the connector and the earphone housing, and wherein the first limiting portion and the second limiting portion are elastically abutted against each other and are movable relative to each other.

2. The earphone according to claim 1, wherein the connector comprises an arc structure, and a shape of the guide groove fits a shape of the connector.

3. The earphone according to claim 1, wherein the second limiting portion comprises a wavy structure.

4. The earphone according to claim 3, wherein the second limiting portion comprises at least two limiting grooves connected in sequence, and the first limiting portion is capable of sequentially moving into the at least two limiting grooves.

5. The earphone according to claim 1, wherein the second limiting portion comprises a damping sheet.

6. The earphone according to claim 1, wherein the first limiting portion is an elastic sheet or a ball.

7. The earphone according to claim 1, wherein the first limiting portion is arranged on the earphone housing, and the second limiting portion is arranged on the connector.

8. The earphone according to claim 7, wherein the first limiting portion comprises an elastic sheet body and a limiting protrusion, wherein the elastic sheet body is disposed on a groove wall of the guide groove, and the limiting protrusion is coupled to the elastic sheet body and protrudes from a side of the elastic sheet body, and wherein the limiting protrusion and the second limiting portion are elastically abutted against each other and are movable relative to each other.

9. The earphone according to claim 8, wherein the groove wall of the guide groove is provided with a first mounting groove, and an end of the elastic sheet body is provided with a bending portion which is disposed in the first mounting groove.

10. The earphone according to claim 8, wherein the first limiting portion comprises a sleeve and a jacking piece movably arranged in the sleeve, the sleeve is provided on the groove wall of the guide groove, and the jacking piece and the sleeve are elastically abutted against each other and is movable relative to each other.

11. The earphone according to claim 10, wherein the groove wall of the guide groove is provided with a second mounting groove, and the sleeve is fixedly disposed in the second mounting groove.

12. The earphone according to claim 1, wherein the earphone housing comprises a housing and a partition provided inside the housing, the partition and a part of an inner wall of the housing define the guide groove, and the opening is formed on the housing.

13. The earphone according to claim 12, wherein the housing comprises a first housing and a second housing connected with each other in a snap-fit manner.

14. The earphone according to claim 13, wherein an edge portion of the first housing is provided with an annular waterproof groove along a circumferential direction, and an edge portion of the second housing is provided with an annular waterproof boss, which fits the annular waterproof groove.

15. The earphone according to claim 12, wherein the housing comprises an accommodating cavity, and a battery is disposed in the accommodating cavity.

16. The earphone according to claim 12, wherein the connector is provided with a wire exiting hole, and the partition is provided with a wire passing hole, wherein the earphone further comprises a wire and a sealing ring, wherein the wire is disposed in the ear hook body and sequentially penetrates through the wire exiting hole and the wire passing hole, and the sealing ring is fitted outside the wire and embedded in the wire passing hole.

17. The earphone according to claim 16, wherein an outer wall of the sealing ring is provided with an annular groove, and an inner wall of the wire passing hole is provided with an annular protrusion fitting the annular groove, so that the sealing ring is in a sealed connection with the wire passing hole.

18. An earphone comprising:
a sound emitting unit comprising an earphone housing, wherein the earphone housing is provided with an opening and a guide groove communicating with the opening;
an ear hook comprising an ear hook body and a connector connected with each other, wherein the ear hook body penetrates through the opening, and the connector is disposed in the guide groove and is movable along the guide groove;
a limiting structure comprising a first limiting portion and a second limiting portion, wherein the first limiting portion is arranged on one of the connector and the earphone housing, and the second limiting portion is arranged on the other of the connector and the earphone housing, and wherein the first limiting portion and the second limiting portion are elastically abutted against each other and are movable relative to each other; and
a battery compartment, wherein the battery compartment is coupled to an end of the ear hook distal from the sound emitting unit.

19. The earphone according to claim 18, wherein the earphone housing comprises a housing and a partition provided inside the housing, the partition and a portion of an inner wall of the housing define the guide groove, and the opening is formed on the housing.

20. The earphone according to claim 19, wherein the connector is provided with a wire exiting hole, and the partition is provided with a wire passing hole, wherein the earphone further comprises a wire and a sealing ring, wherein the wire is disposed in the ear hook body and sequentially penetrates through the wire exiting hole, the wire passing hole, and into the battery compartment, and the sealing ring is fitted on an end of the wire distal from the battery compartment and embedded in the wire passing hole.
